(19) United States
(12) Patent Application Publication
(10) Pub. No.: US 2007/0267995 A1
(43) Pub. Date: Nov. 22, 2007

(54) Six Degree-of-Freedom Stage Apparatus

(75) Inventors: Michael B. Binnard, Belmont, CA (US); Yoichi Arai, Saitama-ken (JP); Douglas C. Watson, Campbell, CA (US); Alton H. Phillips, East Palo Alto, CA (US); Scott Coakley, Belmont, CA (US)

Correspondence Address: AKA CHAN LLP, 900 LAFAYETTE STREET, SUITE 710, SANTA CLARA, CA, 95050, US

(73) Assignee: NIKON CORPORATION, Tokyo (JP)

(21) Appl. No.: 11/750,604

(22) Filed: May 18, 2007

Related U.S. Application Data
(60) Provisional application No. 60/747,556, filed on May 18, 2006.

(51) Int. Cl. B64C 17/06

(52) U.S. Cl. 318/649

(57) ABSTRACT

Methods and apparatus for providing a fine stage with up to six degrees of freedom are disclosed. According to one aspect of the present invention, a stage apparatus includes a first stage assembly, a second stage assembly, and a countermass arrangement. The first stage assembly including a first component of a first actuator, and supports a second actuator arrangement. The second stage assembly is supported over the first stage assembly such that the second actuator arrangement drives the second stage assembly along a vertical axis. The countermass arrangement includes a second component of the first actuator. The first component cooperates with the second component to allow the first stage assembly to move relative to a first horizontal axis. The countermass arrangement absorbs reaction forces associated with the first and second stage assemblies.

### CROSS-REFERENCE TO RELATED APPLICATIONS

This application claims priority of U.S. Provisional Patent Application No. 60/747,556, filed May 18, 2006, which is incorporated herein by reference in its entirety. The present invention is also related to co-pending U.S. patent application Ser. No. 11/750,545, filed May 18, 2007 (Atty. Docket No. NRCAP037/PAO-720), which is incorporated herein by reference in its entirety.

### BACKGROUND OF THE INVENTION

1. Field of Invention

The present invention relates generally to lithographic systems. More particularly, the present invention relates to a stage apparatus which is monolithic and is capable of movement in up to six degrees of freedom.

2. Description of the Related Art

For many machines or instruments such as photolithography machines which are used in semiconductor processing, space is often at a premium. The lack of available space often forces components to be sized as compactly as possible. As a result, restricting the size of components of a stage apparatus allows the space in an overall machine to be efficiently utilized. By way of example, the size of a component that is arranged to provide a particular force or motion allows the space in an overall machine to be efficiently utilized.

Many machines include linear motors which may be used to provide a force that is used to drive an object or a structure, e.g., a stage of a photolithography machine. Since linear motors typically effectively only produce a non-zero net force in a single direction, a linear motor may generally only be used to apply force on an object, as for example a stage assembly, in a single direction such as a y-direction. In order for the object to be moved more than one direction, e.g., both a y-direction and a z-direction, an additional actuator which is arranged to apply a force substantially only in z-direction generally must also be coupled to object. While the use of two actuators may be effective in allowing an object to move in both a y-direction and a z-direction, the use of multiple actuators on a stage assembly may not always be possible due to space constraints within an overall system. Further, the use of an additional actuator may cause issues associated with the addition of mass to the overall system, and the generation of heat within the overall system. As will be appreciated by those skilled in the art, additional mass may cause vibrations within the overall system, while additional heat may adversely affect the performance of various components, e.g., sensors, within the overall system.

A planar motor, i.e., a motor with a substantially flat plate of magnets and coils, is arranged to provide force in an x-direction and a y-direction. Hence, a single planar motor may be used in lieu of two linear motors to provide a non-zero net force in an x-direction and a y-direction. However, a planar motor is generally more complicated to control than a linear motor. Further, since many systems are arranged to use linear motors, the use of a planar motor instead of one or more linear motors may be impractical.

The ability for stage devices, e.g., reticle stages, to move in a z-direction is often critical to ensure the accurate positioning of the stage devices during a photolithography process. Typically, a stage device that may translate relative to an x-direction, a y-direction, and a z-direction also has three degrees of rotational freedom. However, in many systems, adding the capability for a stage device to move in a z-direction is often either impractical or not feasible due to space constraints and other issues.

Non-contact stage devices are preferably such that there are no wires or hoses connected to moving portions of the stage devices. Hence, enabling a non-contact stage device to move in a z-direction, in addition to an x-direction and a y-direction, may be further complicated by the requirement that the non-contact stage device has no mechanical contact with any other structure.

Therefore, what is desired is a non-contact stage device which translates in at least a y-direction and a z-direction. That is, what is needed is a method and an apparatus which allows a monolithic stage device to translate in at least a y-direction and a z-direction, and have up to six degrees of freedom, with substantially no mechanical contact with any other structure.

### BRIEF SUMMARY OF THE INVENTION

The present invention relates to a monolithic fine stage with up to six degrees of freedom. According to one aspect of the present invention, a stage apparatus includes a first stage assembly, a second stage assembly, and a countermass arrangement. The first stage assembly includes a first component of a first actuator, and supports a second actuator arrangement. The second stage assembly is supported over the first stage assembly such that the second actuator arrangement drives the second stage assembly along a vertical axis. The countermass arrangement includes a second component of the first actuator. The first component cooperates with the second component to allow the first stage assembly to move relative to a first horizontal axis. The countermass arrangement absorbs reaction forces associated with the first stage assembly. In one embodiment, the countermass arrangement also includes an x-actuator and a y-actuator for a second stage assembly, and receives a reaction force for the second stage assembly.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is an exploded representation of an overall stage apparatus in accordance with an embodiment of the present invention.

FIG. 2A is a top down diagrammatic representation of a fine stage, i.e., fine stage 104 of FIG. 1, in accordance with an embodiment of the present invention.

FIG. 2B is a side view diagrammatic representation of a fine stage, i.e., fine stage 104 of FIGS. 1 and 2A, in accordance with an embodiment of the present invention.

FIG. 3 is a diagrammatic representation of carrier stages, i.e., carrier stages 108a and 108b of FIG. 1, in accordance with an embodiment of the present invention.

FIG. 4A is a top down diagrammatic representation of a reaction mass assembly, i.e., reaction mass assembly 112 of FIG. 1, in accordance with an embodiment of the present invention.

FIG. 4B is a side view diagrammatic representation of a fine stage, a reaction mass assembly, i.e., reaction mass assembly 112 of FIGS. 1 and 4A, in accordance with an embodiment of the present invention.

FIG. 5 is a diagrammatic representation of a base frame assembly, i.e., base frame assembly 116 of FIG. 1, in accordance with an embodiment of the present invention.

FIG. 6 is a diagrammatic representation of an overall stage apparatus, i.e., overall stage apparatus 100 of FIG. 1, in accordance with an embodiment of the present invention.

FIG. 7 is a diagrammatic representation of an overall twin stage apparatus in accordance with an embodiment of the present invention.

FIG. 8A is a diagrammatic representation of a Z actuator in accordance with an embodiment of the present invention.

FIG. 8B is a diagrammatic representation of a first view of a first component of a mover for a Z actuator, i.e., Z actuator 800 of FIG. 8A, in accordance with an embodiment of the present invention.

FIG. 8C is a diagrammatic representation of a second view of a first component of a mover for a Z actuator, i.e., first component 864 of FIG. 8B, in accordance with an embodiment of the present invention.

FIG. 8D is a diagrammatic representation of a stator for a Z actuator, i.e., Z actuator 810 of FIG. 8A, in accordance with an embodiment of the present invention.

FIG. 9A is a diagrammatic side view representation of a stage system in accordance with one embodiment of the present invention.

FIG. 9B is a diagrammatic perspective representation of a stage system, i.e., stage system 900 of FIG. 9A, in accordance with an embodiment of the present invention.

FIG. 9C is a diagrammatic perspective representation of a Z actuator carrier arrangement of a stage system, i.e., stage system 900 of FIG. 9A, in accordance with an embodiment of the present invention.

FIG. 10 is a block diagram top view representation of a carrier stage arrangement and a fine stage in which Z actuators carried on the carrier stage are in a first orientation in accordance with an embodiment of the present invention.

FIG. 11 is a block diagram top view representation of a carrier stage arrangement and a fine stage in which Z actuators carried on the carrier stage are in a second orientation in accordance with an embodiment of the present invention.

FIG. 12 is a diagrammatic representation of a photolithography apparatus in accordance with an embodiment of the present invention.

FIG. 13 is a process flow diagram which illustrates the steps associated with fabricating a semiconductor device in accordance with an embodiment of the present invention.

FIG. 14 is a process flow diagram which illustrates the steps associated with processing a wafer, i.e., step 1304 of FIG. 13, in accordance with an embodiment of the present invention.

### DETAILED DESCRIPTION OF THE INVENTION

When a stage such as a reticle stage has the capability to move in up to six degrees of freedom, the accuracy with which a reticle may be positioned is enhanced. In many stage systems, however, providing the capability for a stage to move in a z-direction is often difficult due to space constraints.

Utilizing a carrier stage with three degrees of freedom, e.g., two translational degrees of freedom and one rotational degree of freedom, to carry an actuator arrangement and to support a monolithic fine stage enables the monolithic fine stage to have up to six degrees of freedom. Cables and hoses associated with the actuator arrangement may be a part of the carrier stage, and the carrier stage may be used to provide three degrees of freedom to the monolithic fine stage, while a second actuator arrangement preferably attached to a countermass may be used to provide another three degrees of freedom to the monolithic fine stage.

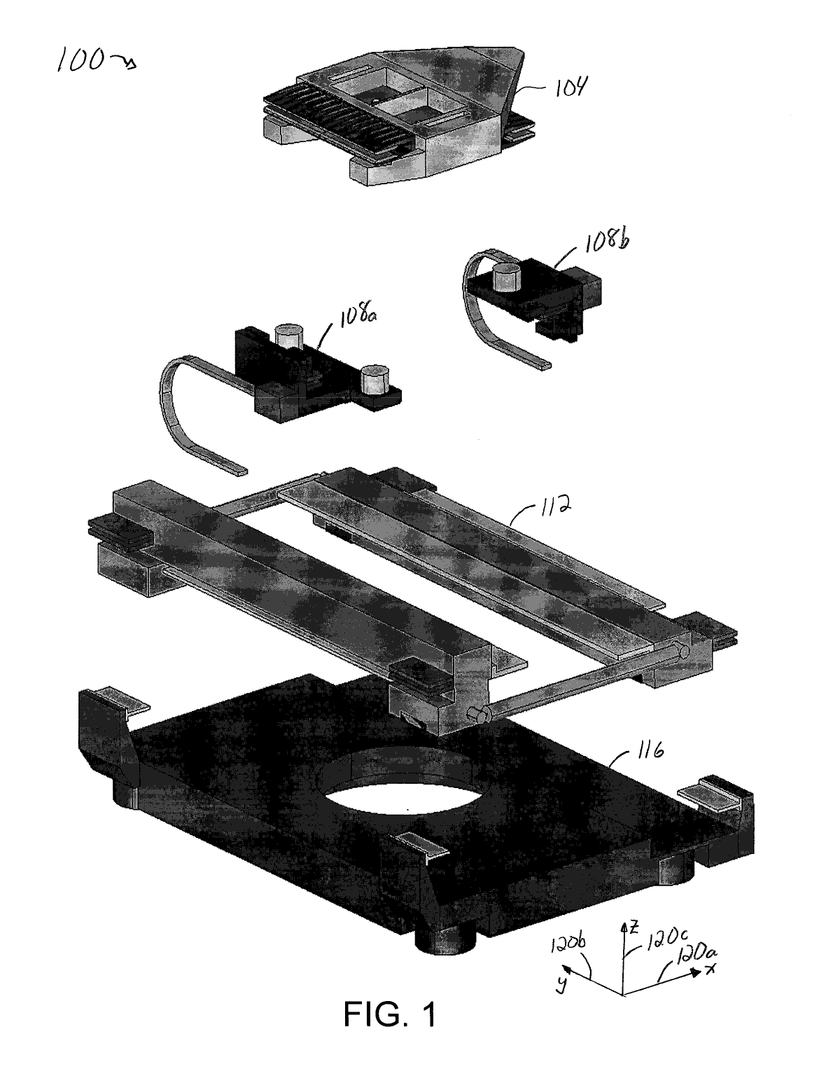

FIG. 1 is an exploded representation of an overall stage apparatus in accordance with an embodiment of the present invention. A stage apparatus 100 includes a reticle stage 104 that is lightweight, and of a monolithic structure. In the described embodiment, reticle stage 104 is a fine stage with up to six degrees of freedom, and is arranged to hold two reticles (not shown). Reticle stage 104 is arranged to be supported over carrier stages 108a, 108b which have a relatively low moving mass. Each carrier stage 108a, 108b is arranged to move in one degree of freedom, e.g., along a y-axis 120b.

Carrier stages 108a, 108b are arranged over a countermass 112. Countermass 112 typically is allowed to move along an x-axis 120a, along y-axis 120b, and about a z-axis 120c. A base frame arrangement 116 is arranged substantially beneath countermass 112 to support countermass 112 and carrier stages 108a, 108b.

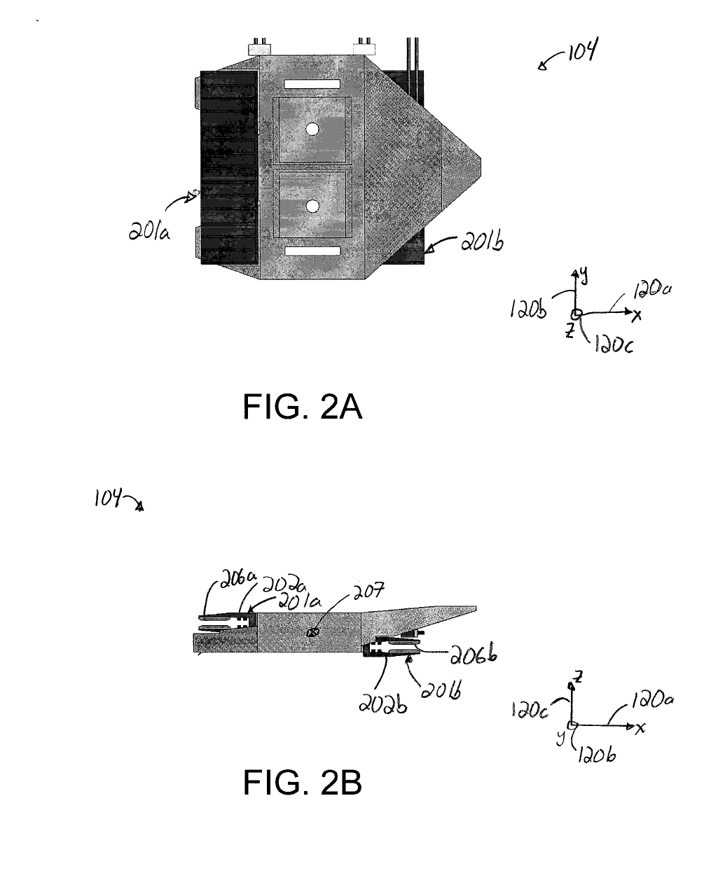

With reference to FIGS. 2A and 2B, reticle stage 104 will be described in accordance with an embodiment of the present invention. Reticle stage 104 has first and second motor arrangements 201a, 201b. First motor arrangement 201a includes magnets 202a for a first voice coil motor (VCM) that is arranged to allow reticle stage 104 to translate relative to x-axis 120a and a magnet arrangement 206a associated with a three-phase actuator, e.g., a linear motor, that provides translation relative to y-axis 120b. Similarly, second motor arrangement 201b includes magnets 202b for a second VCM that is arranged to allow reticle stage 104 to translate relative to x-axis 120a and a magnet arrangement 206b associated with a three-phase actuator that provides translation relative to y-axis 120b. Motor arrangements 201a, 201b are effectively actuators that provide movement along both x-axis 120a and y-axis 120b.

Although motor arrangement 201a and motor arrangement 201b are offset from one another relative to z-axis 120, it should be appreciated that motor arrangement 201a and motor arrangement 201b may instead be aligned with each other relative to z-axis 120. Typically, motor arrangement 201a and motor arrangement 201b are arranged such that net forces applied by motor arrangement 201a and motor arrangement 201b effectively push through a center of gravity 207 of reticle stage 104.

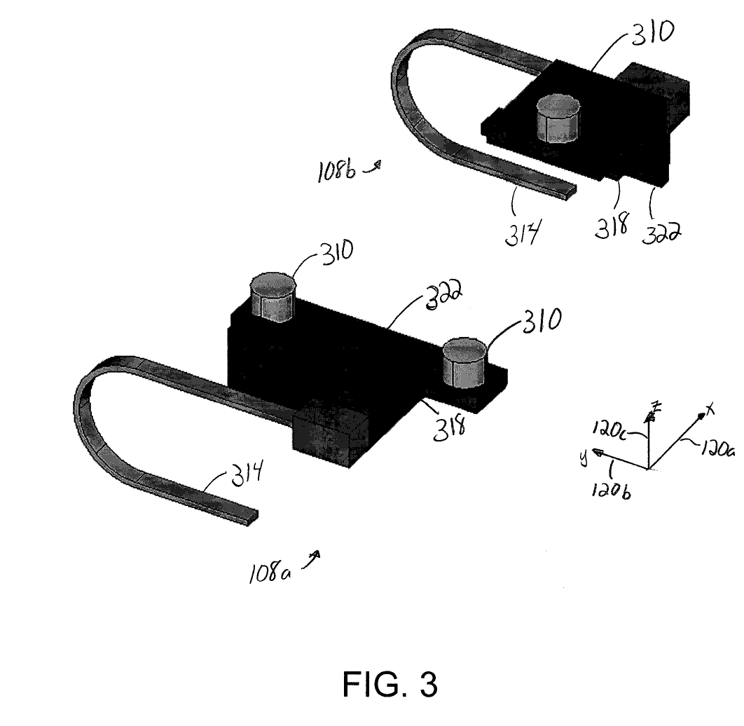

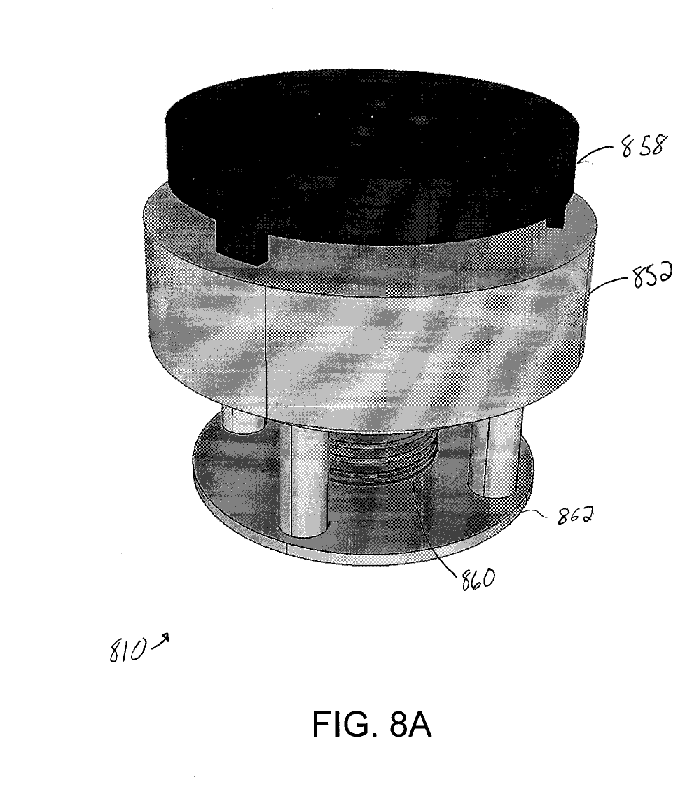

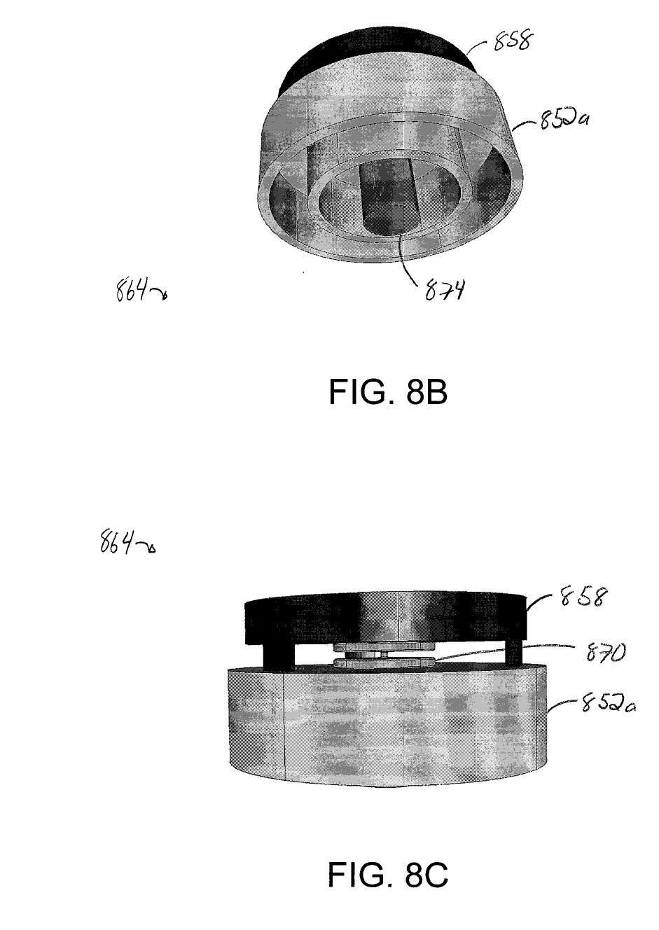

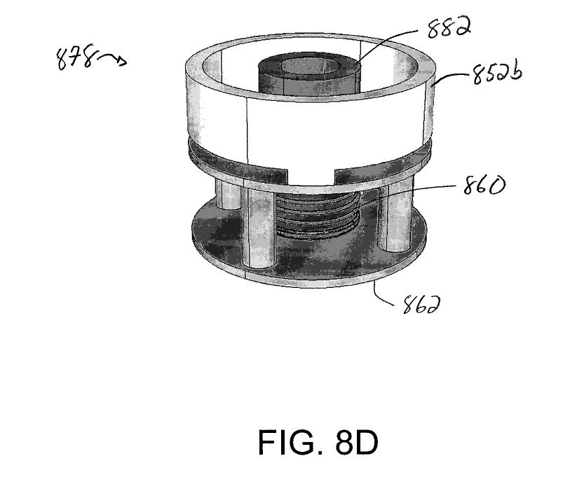

FIG. 3 is a diagrammatic representation of carrier stages 108a, 108b in accordance with an embodiment of the present invention. Carrier stages 108a, 108b are arranged to carry actuators 310 which effectively allow reticle stage 104, which is described above with respect to FIGS. 2A and 2B, to translate relative to z-axis 120c, and to rotate about both x-axis 120a and y-axis 120b. In general, actuators 310 effectively provide vertical control forces, as well as anti-gravity capabilities that do not produce a significant amount of additional heat. As shown, carrier stage 108a may carry two actuators 310, while carrier stage 108b may carry one actuator 310. Actuators 310 may be VCMs, although actuators 310 are not limited to being VCMs. One embodiment that is suitable for use as an actuator 310 and includes a VCM will be described below with respect to FIGS. 8A-8D.

Each carrier stage 108a, 108b is arranged to move over base arrangement 116 of FIG. 1. Cables 314 are arranged to provide power to actuators 310, as well as air and vacuum to carrier stages 108a, 108b. Carrier stage motors 318 allow carrier stages 108a, 108b to translate along y-axis 120b. Typically, carrier stage motors 318 may be three-phase linear motors. Carrier stage motors 318 are positioned such that a net force of carrier motors 318 acts substantially on the center of gravity of each carrier stage 108a, 108b. Air bearings 322 allow carrier stages 108a, 108b to move substantially without friction over base arrangement 116 of FIG. 1.

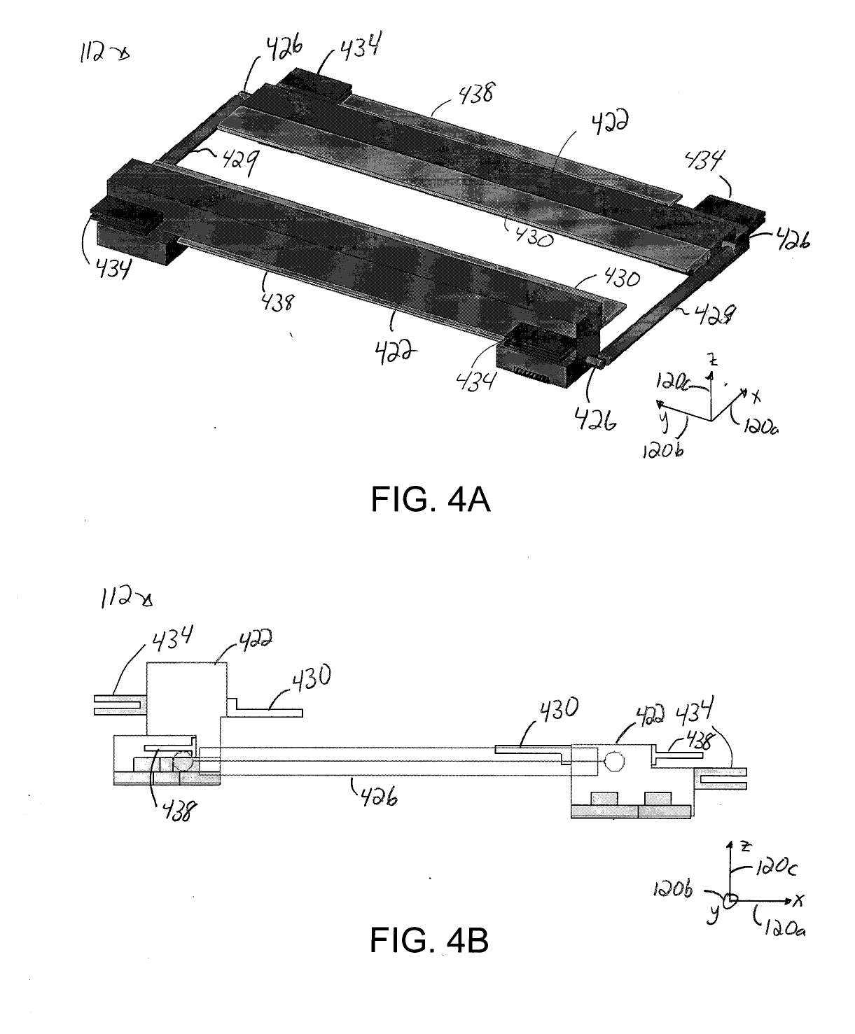

Referring next to FIGS. 4A and 4B, countermass 112 of FIG. 1 will be described in accordance with an embodiment of the present invention. Countermass 112 is effectively a reaction mass with up to four degrees of freedom, and is arranged to substantially surround a working area of stage 100 of FIG. 1. The degrees of freedom may include translational degrees of freedom along x-axis 120a and y-axis 120b, a rotational degree of freedom about z-axis 120c, and differential motion relative to y-axis between two sides of countermass 112. Countermass 112 is composed of two masses 422 that are coupled by flexures 426. Pairs of flexures 426 may be coupled using connecting rods 429. The use of flexures 426 to couple substantially rigid masses 422 allows masses 422 to move relative to one another in y-direction 120b. The flexibility provided by flexures 426 enables countermass 112 to have almost no vibratory motion, or to have vibrations modes that are sufficiently higher or lower than a control bandwidth.

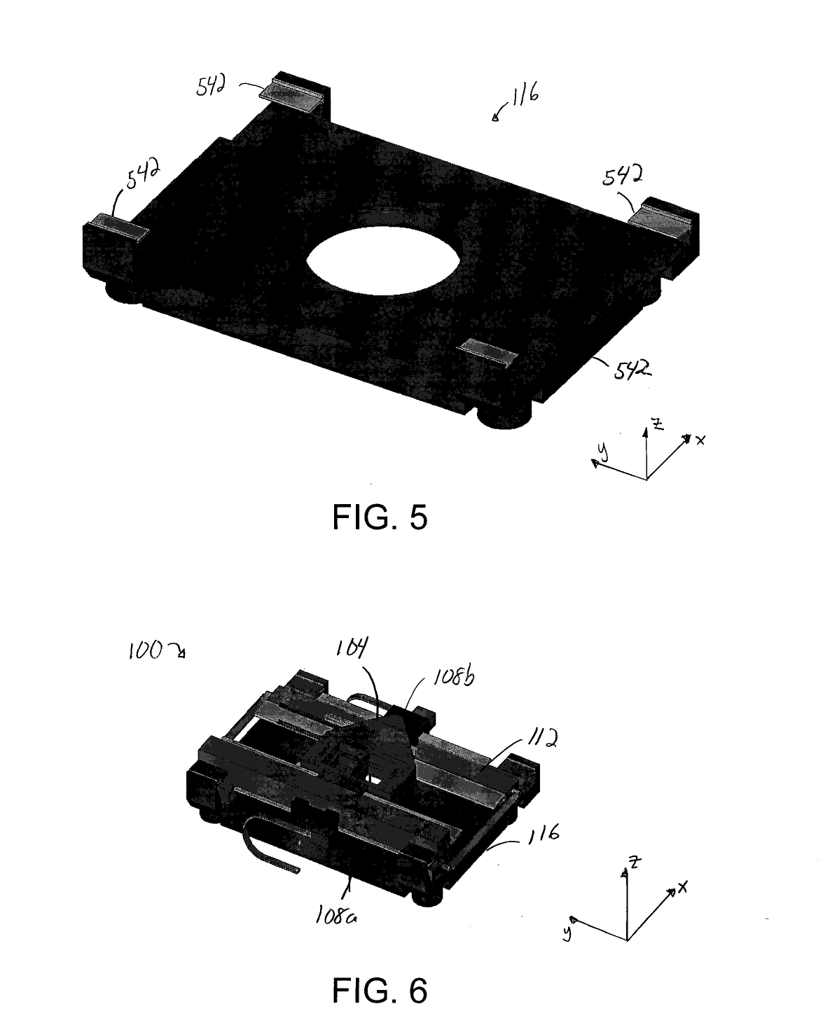

In addition to masses 422 and flexures 426, countermass 112 also includes stators for actuators that provide translation movements within stage apparatus 100 of FIG. 1. Stators 430 are associated with reticle stage 104 such that stators 430 cooperate with motor arrangements 201a, 201b, as shown in FIGS. 2A and 2B, to provide movement of reticle stage 104 along x-axis 120a and y-axis 120b. Stators 438 are arranged to enable carrier stages 108a, 108b of FIG. 1 to translate along x-axis 120b. Trim motor portions 434 are arranged to cooperate with trim motor portions on base frame arrangement 116 of FIG. 1, as will be discussed below with reference to FIG. 5.

FIG. 5 is a diagrammatic representation of base frame assembly 116 of FIG. 1 in accordance with an embodiment of the present invention. Base frame assembly 116 serves as a base over which reticle stage 104 of FIG. 1 may scan, and also supports countermass 112 and carrier stages 108a, 108b of FIG. 1. In addition, base frame assembly 116 may be considered to be an active vibration isolation system (AVIS), as base frame assembly 116 may isolate apparatus 100 from external vibrations.

Trim motor portions 542 are arranged to provide, in cooperation with trim motor portions 434 of FIG. 5, trimming capabilities to countermass 112. Trim motors provide x and y forces that are arranged to correct errors in the position of countermass 112. In the described embodiment, a trim motor is a VCM. However, it should be appreciated that a trim motor is not limited to being a VCM.

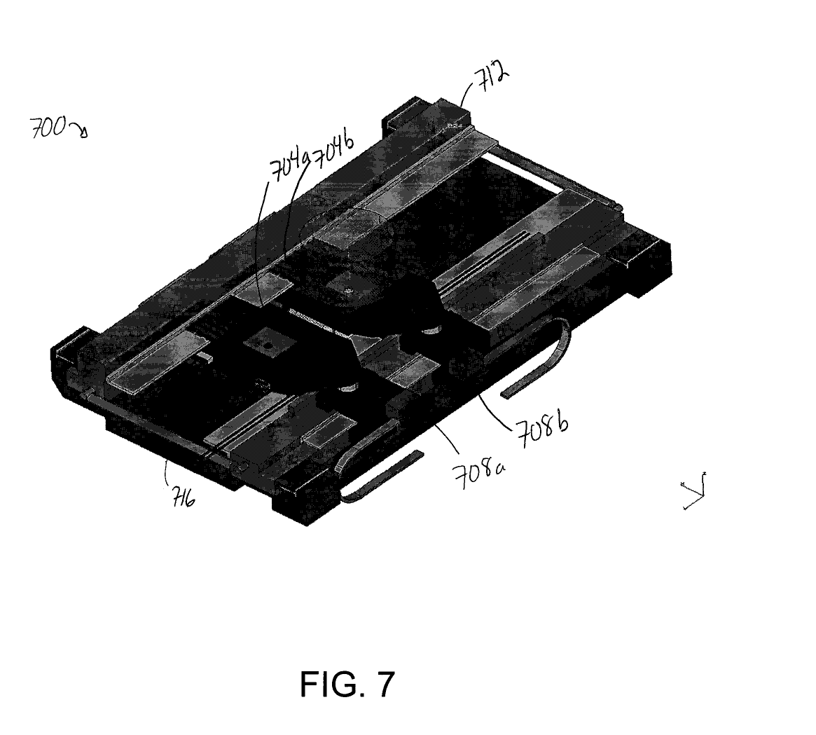

As shown in FIG. 6, when stage apparatus 100 is assembled, reticle stage 104 and countermass 112 are supported over base frame assembly 116, and carrier stages 108a, 108b are arranged substantially beneath reticle stage 104. It should be appreciated that the configuration of substantially any component of stage apparatus 100 may vary. By way of example, the configuration of reticle stage 104 may vary. Instead of being arranged to accommodate a plurality of reticles (not shown), reticle stage 104 may accommodate a single reticle. Alternatively, a plurality of reticle stages may be included in a stage apparatus. FIG. 7 is a diagrammatic representation of an overall twin stage apparatus in accordance with an embodiment of the present invention. A stage apparatus 700 includes a plurality of reticle stages 704a, 704b. Each reticle stage 704a, 704b is associated with carrier stages 708a, 708b, respectively. Like stage apparatus 100 of FIG. 1, stage apparatus 700 includes a planar countermass 712 that includes two masses that are coupled using a flexure. A base frame arrangement 716 provides support to countermass 712 and carrier stages 708a, 708b.

A Z actuator that is carried on a carrier stage, e.g., Z actuator 310 of FIG. 3, may be any suitable actuator. By way of example, a Z actuator may be an arrangement that includes a VCM. FIG. 8A is a diagrammatic representation of a Z actuator that includes a VCM in accordance with an embodiment of the present invention. A Z actuator 810 is arranged to be carried on a carrier stage (not shown) such that Z actuator 810 may provide a structure supported thereon, e.g., a fine stage (not shown), with a vertical degree of freedom.

Z actuator 810 includes a VCM 852, an antigravity arrangement 860, and an air bearing arrangement 858. Z actuator 810 also includes a base 862 that is arranged to be coupled to a surface such as a surface of a carrier stage (not shown). Air bearing arrangement 858 is arranged to support a structure such as a reticle fine stage. Z actuator 810 also includes a tilting flexure (not shown). The tilting flexure is arranged to allow a reticle fine stage to rotate about an x-direction and a y-direction. In general, Z actuator 810 includes a mover component and a stator component. FIGS. 8B and 8C are diagrammatic representation of a mover component in accordance with an embodiment of the present invention. A mover component 864 includes a magnet 852a of VCM 852 and air bearing arrangement 858. Air bearing arrangement 858 may be a vacuum preloaded air bearing that provides a bearing surface between air bearing arrangement 858 and a structure supported thereon.

A tilting flexure 870 is positioned between air bearing arrangement 858 and magnet 852a. A guide shaft 874 extends through an interior of mover 864 and is arranged to be positioned in an air bushing guide (not shown) of a stator. Guide shaft 874 allows mover 864 to be aligned with the stator.

FIG. 8D is a diagrammatic representation of a stator for Z actuator 810 of FIG. 8A in accordance with an embodiment of the present invention. A stator 878 includes a coil arrangement 852b of VCM 852. Coil arrangement 852b may include a coil and a cooling can. When a current is applied to the coil, magnet 852a of FIGS. 8B and 8C may move relative to coil arrangement 852b. An air bushing guide 882 is positioned substantially within stator 878, and accommodates guide shaft 874 of FIG. 8B. Antigravity arrangement 860 is an air bellows in the described embodiment, although antigravity arrangement 860 may be substantially any arrangement that enables Z actuator 810 to provide support against gravity forces substantially without generating heat near the stage apparatus. Base 862 allows stator 878 to be attached to a carrier stage or other support structure.

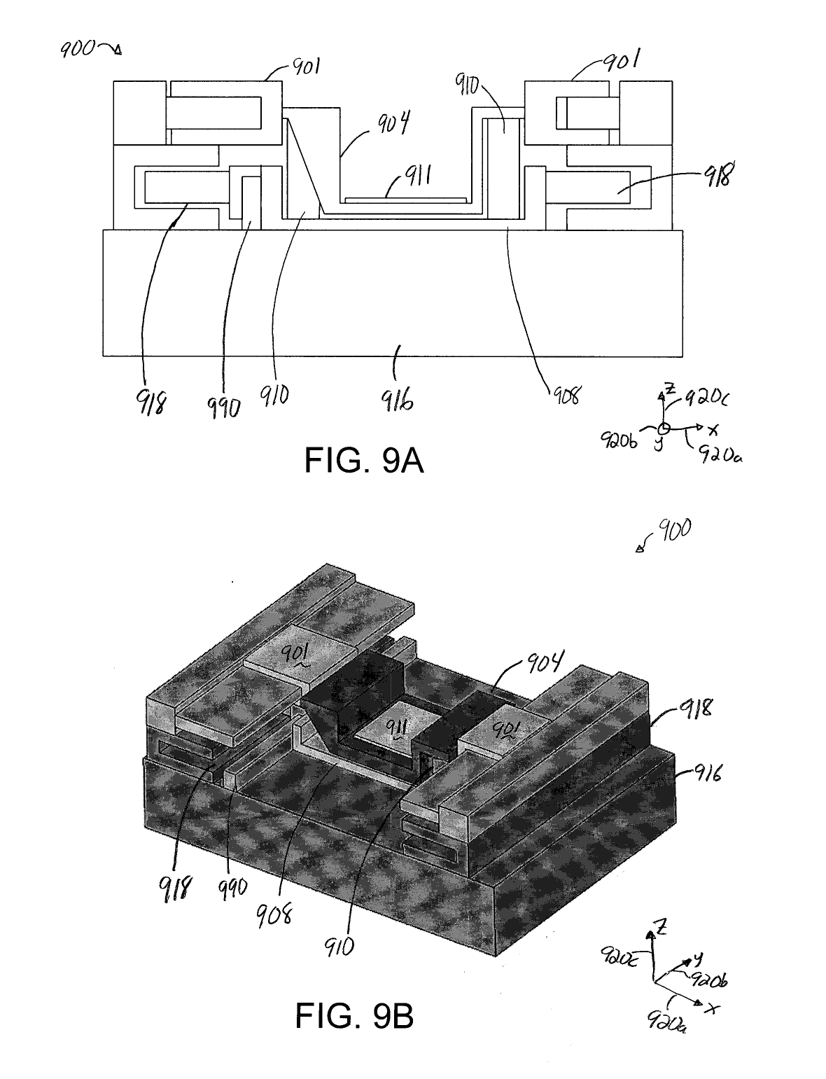

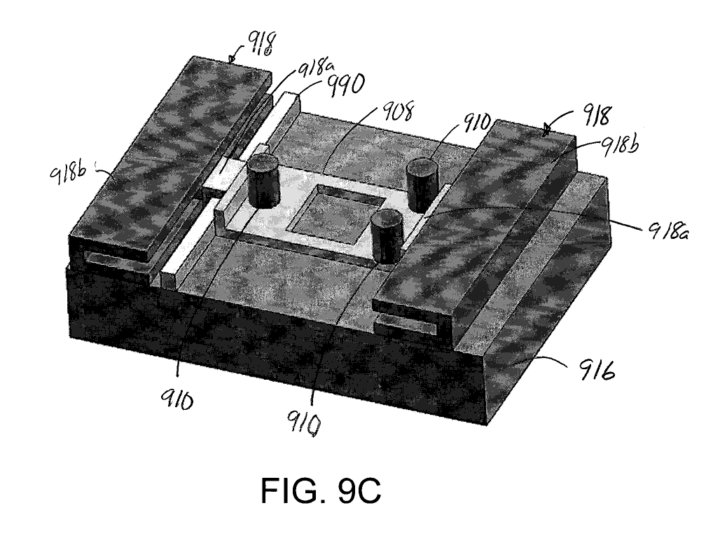

The design of a stage apparatus which uses a carrier stage with three degrees of freedom to carry a monolithic stage such that the monolithic stage has up to six degrees of freedom may vary. FIG. 9A is a diagrammatic side view representation of a stage system and FIG. 9B is a diagrammatic perspective representation of the same stage system in accordance with one embodiment of the present invention. A stage system 900 includes a monolithic stage 904 and a carrier stage 908 that are positioned over a base arrangement 916. Although a countermass is not shown, it should be understood that stage system 900 may include a countermass similar to countermass 112 of FIG. 1.

Monolithic stage 904 is generally a fine stage that provides fine positioning, and carrier stage 908 is generally a lower accuracy stage that supports fine stage 904. In one embodiment, monolithic stage 904 is a reticle stage or a reticle holder that supports a reticle 911.

Drive actuators 901 are arranged to drive monolithic stage 904 at least along a y-axis 920b. Typically, drive actuators 901 drive monolithic stage 904 along both y-axis 920b and an x-axis 920a. Z actuators 910 are carried on carrier stage 908, and allow monolithic stage 904 to move relative to a z-axis 920c. Stage system 900 may include three or more Z actuators 910 such that monolithic stage 904 may translate relative to z-axis 920c, and rotate relative to x-axis 920a and y-axis 920b using Z actuators 910. Carrier stage 908 is driven by actuators 918 along y-axis 920b. A yaw guide 990 is arranged to constrain carrier stage 908 from moving along x-axis 920a or rotating about z-axis 920c. Typically, actuators 901, 918 may be coupled between fine stage 904 and carrier stage 908 and a countermass (not shown).

With reference to FIG. 9C, carrier stage 908 is shown in more detail in accordance with an embodiment of the present invention. Carrier stage 908 supports a plurality of Z actuators 910. Yaw guide 990, which may be an air bearing guide, is coupled to base arrangement 916. Actuators 918, which include stators 918b and movers 918a, are arranged to drive carrier stage 908. Although stators 918b are shown as being supported on base arrangement 916, stators 918b may be a part of a countermass arrangement (not shown) that is supported over base arrangement 916.

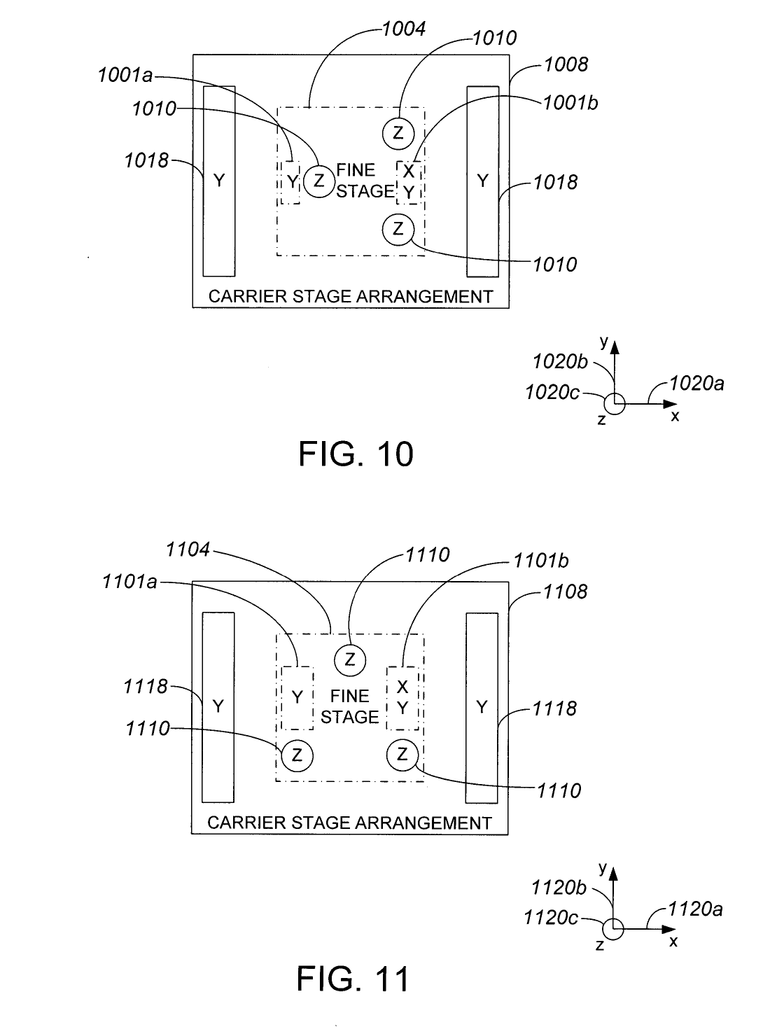

The orientation of Z actuators, or an actuator arrangement, supported on a carrier stage, may vary depending on the requirements of a particular system. That is, specifications associated with a given stage apparatus may determine how actuators carried on a carrier stage are arranged. FIG. 10 is a block diagram top view representation of a carrier stage arrangement and a fine stage in which Z actuators carried on the carrier stage are in a first orientation in accordance with an embodiment of the present invention. A carrier stage arrangement 1008 may include one or more carrier stages which carry Z actuators 1010 and are arranged to translate along a y-axis 1020b using actuators 1018. In the embodiment as shown, two Z actuators 1010 are aligned along y-axis 1020b.

Z actuators 1010 are positioned beneath a fine stage 1004 such that fine stage 1004 may rotate about an x-axis 1020a and about y-axis 1020b, and translate along a z-axis 1020c. Fine stage 1004 includes motor arrangements 1001a, 1001b that drive fine stage 1004 along x-axis 1020a, y-axis 1020b, and about z-axis 1020c. It should be understood that portions of actuators 1018 and motor arrangements 1001a, 1001b may be included in a countermass (not shown).

FIG. 11 is a block diagram top view representation of a carrier stage arrangement and a fine stage in which Z actuators carried on the carrier stage are in a second orientation in accordance with an embodiment of the present invention. A carrier stage arrangement 1108 may generally include one or more carrier stages which carry Z actuators 1110. Two Z actuators 1110 are aligned with one another along a y-axis 1120b. Carrier stage arrangement 1108 is arranged to translate along y-axis 1120b using actuators 1118.

Z actuators 1110 are positioned beneath a fine stage 1104. Using Z actuators 1110, fine stage 1104 may rotate about an x-axis 1102a, rotate about y-axis 1102b, and translate along a z-axis 1102c. Fine stage 1104 includes motor arrangements 1101a, 1101b that drive fine stage 1104 along x-axis 1120a, y-axis 1120b, and about z-axis 1120c.

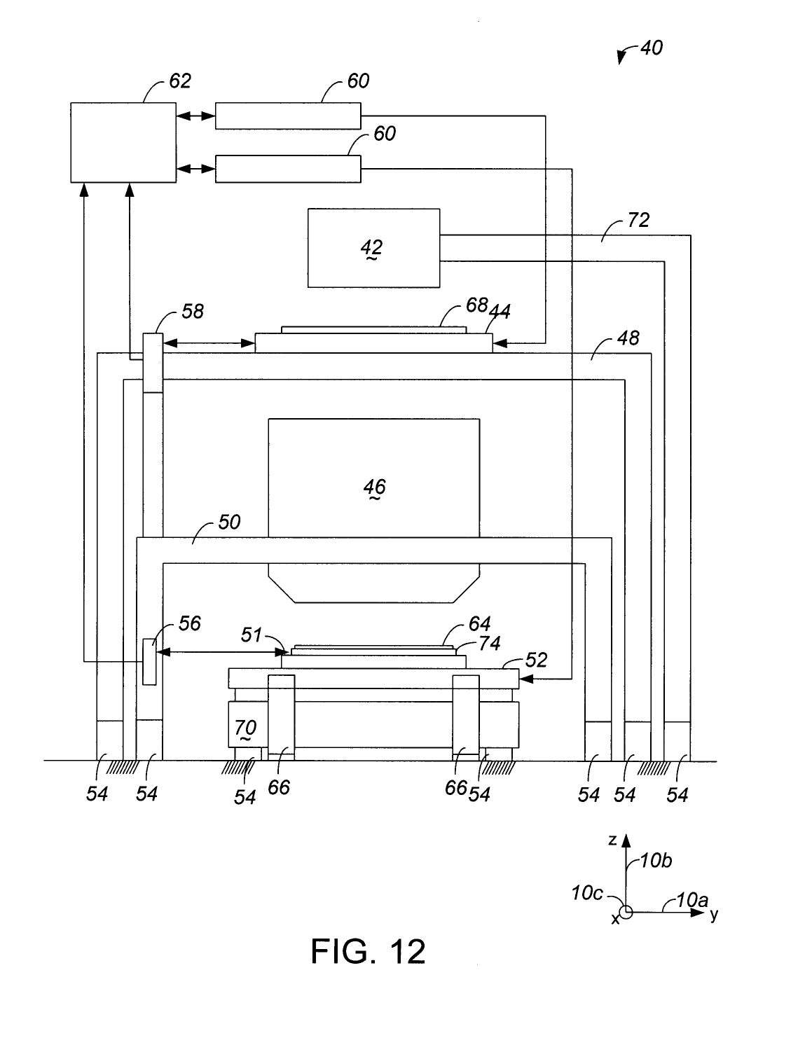

Referring next to FIG. 12, a photolithography apparatus which may utilize a monolithic stage arrangement that allows for motion along both a y-axis and a z-axis will be described in accordance with an embodiment of the present invention. A photolithography apparatus (exposure apparatus) 40 includes a wafer positioning stage 52 that may be driven by linear or planar motors (not shown), as well as a wafer table 51 that is magnetically coupled to wafer positioning stage 52. The motor which drives or motors which drive wafer positioning stage 52 generally utilize an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between two to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of VCMs (not shown), e.g., three voice coil motors. In one embodiment, at least three magnetic bearings (not shown) couple and move wafer table 51 along a y-axis 10a along x-axis 10c and about z-axis 10b. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Frame 72 may be part of a lens mount system of illumination system 42, and may be coupled to an active damper (not shown) which damps vibrations in frame 72 and, hence, illumination system 42. Illumination system 42 includes an illumination source, and is arranged to project a radiant energy, e.g., light, through a mask pattern on a reticle 68 that is supported by and scanned using a reticle stage 44 which includes a carrier stage and a fine stage, as described above. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. A second interferometer 58 is supported on projection optics frame 50, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64, and then that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

Further, the present invention may be utilized in an exposure apparatus that comprises two or more substrate and/or reticle stages. In such an apparatus, e.g., an apparatus with two substrate stages, one substrate stage may be used in parallel or preparatory steps while the other substrate stage is utilizes for exposing. Such a multiple stage exposure apparatus is described, for example, in Japan patent Application Disclosure No. 10-163099, as well as in Japan patent Application Disclosure No. 10-214783 and its U.S. counterparts, namely U.S. Pat. No. 6,341,007, U.S. Pat. No. 6,400,441, U.S. Pat. No. 6,549,269, U.S. Pat. No. 6,590,634. Each of these Japan patent Application Disclosures and U.S. patents are incorporated herein by reference in their entireties. A multiple stage exposure apparatus is also described in Japan patent Application Disclosure No. 20000-505958 and its counterparts U.S. Pat. No. 5,969,441 and U.S. Pat. No. 6,208,407, each of which are incorporated herein by reference in their entireties.

The present invention may be utilized in an exposure apparatus that has a movable stage that retains a substrate (wafer) for exposure, as well as a stage having various sensors or measurement tools, as described in Japan patent Application Disclosure No. 11-135400, which is incorporated herein by reference in its entirety. In addition, the present invention may be utilized in an exposure apparatus that is operated in a vacuum environment such as an EB type exposure apparatus and a EUVL type exposure apparatus when suitable measures are incorporated to accommodate the vacuum environment for air (fluid) bearing arrangements.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces, i.e., vibrational forces, which are experienced by a stage assembly or, more generally, by a photolithography machine such as photolithography apparatus 40 which includes a stage assembly.

A photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

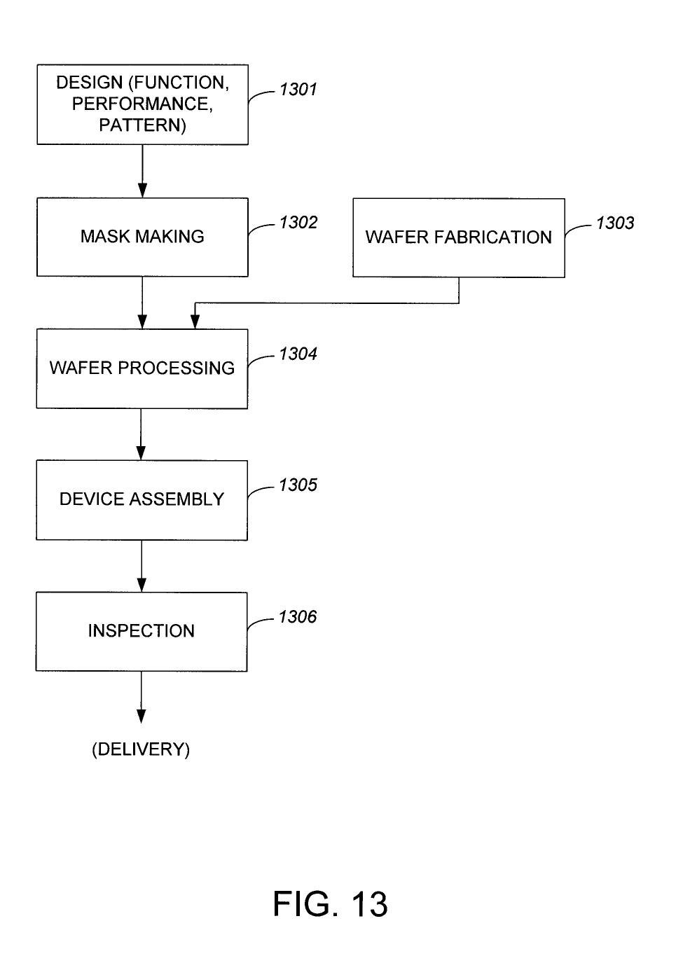

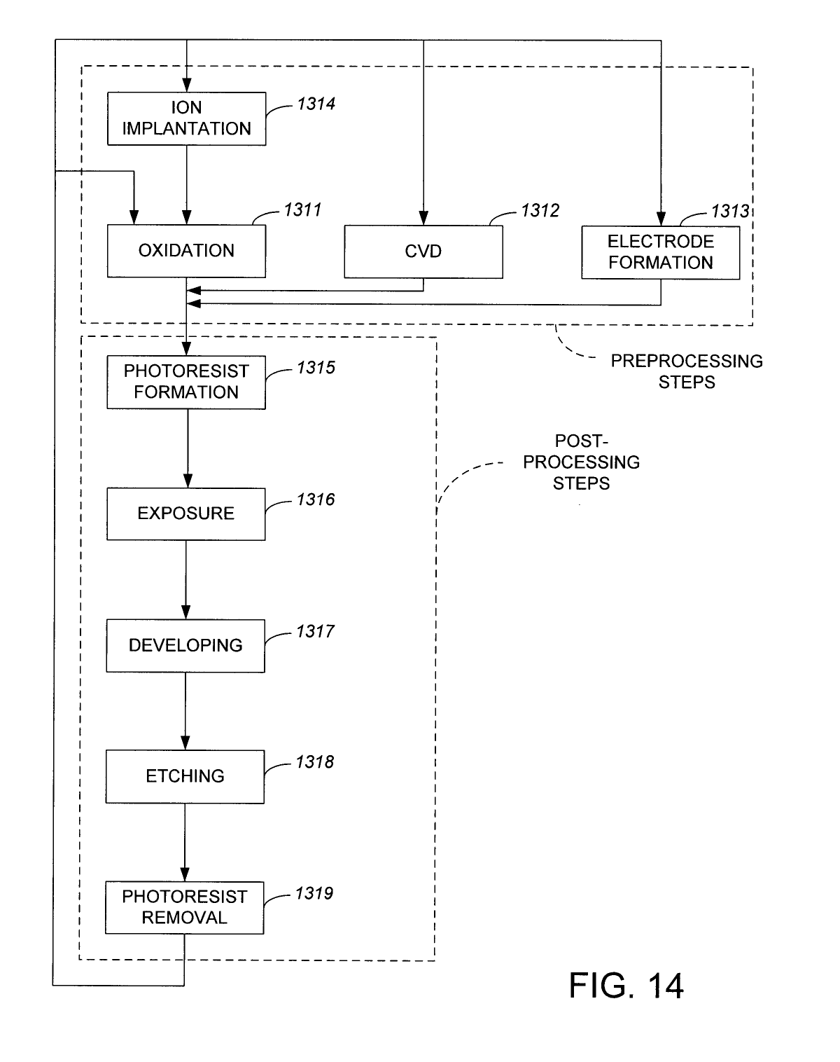

Further, semiconductor devices may be fabricated using systems described above, as will be discussed with reference to FIG. 13. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 14. In step 1305, the semiconductor device is assembled. The assembly of the semiconductor device generally includes, but is not limited to, wafer dicing processes, bonding processes, and packaging processes. Finally, the completed device is inspected in step 1306.

FIG. 14 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage. It should be appreciated that when the circuit pattern of the reticle is transferred to the wafer, an automatic reticle blind is generally in an open position to allow a laser beam to pass therethrough.

After the circuit pattern on a reticle is transferred to a wafer, the exposed wafer is developed in step 1317. Once the exposed wafer is developed, parts other than residual photoresist, e.g., the exposed material surface, may be removed by etching in step 1318. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, the configuration of motor arrangements that drive a fine stage along horizontal axes may vary. Further, the alignment of such motor arrangements may also vary. As described above, motor arrangements which drive a fine stage along an x-axis and a y-axis may be aligned in substantially any manner that enables the fine stage to be driven through a center of gravity.

While a fine stage has been described as being a reticle stage, a fine stage may instead be a wafer stage, i.e., a stage that supports a wafer. Further, a reticle stage may not necessarily be a fine stage, e.g., stage 104 of FIG. 1 may be a coarse stage.

The number of actuators in a stage apparatus may vary widely. By way of example, more than three Z actuators may be supported on a carrier stage arrangement. Further, the number of motor arrangements that drive a fine stage along a horizontal axis may vary. Separate actuators may provide movement along each horizontal axis, i.e., a motor arrangement may not necessarily be a combined actuator that is capable of providing translational movement along more than one axis. In one embodiment, a fine stage may be driven by approximately four 3-phase motors along a y-axis, and by one VCM in an x-direction.

Stators associated with motors which allow a carrier stage to be driven and controlled may generally be considered to be part of a countermass frame. That is, a countermass may include the mass associated with motor stators. As previously mentioned, a countermass may have a variety of different configurations. Therefore, the present examples are to be considered as illustrative and not restrictive, and the invention is not to be limited to the details given herein, but may be modified within the scope of the appended claims.

1. A stage apparatus comprising:
a countermass arrangement, the countermass arrangement including at least a first component of a first actuator arrangement and a first component of a second actuator arrangement, wherein the countermass is arranged to absorb reaction forces associated with the first actuator arrangement and the second actuator arrangement;
a first stage assembly, the first stage assembly including a second component of the first actuator arrangement, wherein the first actuator arrangement is arranged to drive the first stage assembly in at least one horizontal direction; and
a second stage assembly, the second stage assembly being arranged to carry a third actuator arrangement, the third actuator arrangement being capable of driving the first stage assembly in a vertical direction, wherein the second stage assembly includes a second component of the second actuator arrangement, the second actuator arrangement being arranged to drive the second stage assembly in the at least one horizontal direction.

2. The stage apparatus of claim 1 wherein the third actuator arrangement includes an air bearing, the air bearing being arranged to be interfaced with the first stage assembly.

3. The stage apparatus of claim 1 wherein the second stage assembly includes a first stage and a second stage.

4. The stage apparatus of claim 1 wherein the first stage assembly is a monolithic stage assembly.

5. The stage apparatus of claim 1 wherein the stage apparatus is part of an exposure apparatus.

6. A device manufactured with the exposure apparatus of claim 5.

7. A wafer on which an image has been formed by the exposure apparatus of claim 5.

8. The stage apparatus of claim 1 further including:
a third stage assembly, the third stage assembly including a portion of a fourth actuator arrangement, wherein the fourth actuator arrangement is arranged to drive the third stage assembly in the at least one horizontal direction; and
a fourth stage assembly, the fourth stage assembly being arranged to carry a fifth actuator arrangement, the fifth actuator arrangement being capable of driving the third stage assembly in the vertical direction, wherein the fourth stage assembly includes a portion of a fifth actuator arrangement, the fifth actuator arrangement being arranged to drive the fourth stage assembly in the at least one horizontal direction.

9. A stage apparatus comprising:
a first stage assembly, the first stage assembly including a first component of a first actuator, wherein the first stage assembly supports a second actuator arrangement;
a second stage assembly, the second stage assembly being supported over the first stage assembly such that the second actuator arrangement drives the second stage assembly along a vertical axis, wherein the second stage assembly includes a first part of a third actuator arrangement, the third actuator arrangement being capable of driving the second stage assembly along a first horizontal axis and along a second horizontal axis; and
a countermass arrangement, the countermass arrangement including a second component of the first actuator, wherein the first component is arranged to cooperate with the second component to allow the first stage assembly to move relative to the first horizontal axis, and wherein the countermass arrangement is arranged to absorb reaction forces associated with the first stage assembly.

10. The stage apparatus of claim 9 wherein the countermass arrangement includes a first mass and a second mass, the first mass and the second mass being arranged to support the second component, the first mass and the second mass being coupled by a flexure.

11. The stage apparatus of claim 9 wherein the second actuator arrangement is further arranged to drive the second stage assembly about the first horizontal axis and about a second horizontal axis.

12. The stage apparatus of claim 11 wherein the second actuator arrangement includes at least three assemblies, the at least three assemblies each having a voice coil motor (VCM) and an anti-gravity mechanism.

13. The stage apparatus of claim 9 wherein the countermass arrangement includes a second part of the third actuator arrangement, and wherein the first part and the second part cooperate to drive the second stage assembly along the first horizontal axis and along the second horizontal axis.

14. The stage apparatus of claim 9 wherein the third actuator arrangement is arranged to drive the second stage assembly through a center of gravity of the second stage assembly.

15. The stage apparatus of claim 9 wherein the second stage assembly is a reticle stage assembly.

16. The stage apparatus of claim 9 wherein the stage assembly is a monolithic stage assembly.

17. The stage apparatus of claim 9 wherein the stage apparatus is part of an exposure apparatus.

18. A device manufactured with the exposure apparatus of claim 17.

19. A wafer on which an image has been formed by the exposure apparatus of claim 17.

20. A method for operating stage apparatus that includes a first stage, a second stage arrangement, and a countermass arrangement, the method comprising:
driving the first stage using a first actuator assembly, the first actuator assembly being associated with the first stage and the countermass arrangement, wherein driving the first stage using the first actuator assembly includes directly driving the first stage along at least one selected from a group including a first axis and a second axis; and
driving the second stage arrangement along the first axis using a second actuator, the second actuator being associated with the second stage arrangement and the countermass arrangement, wherein driving the second stage arrangement along the first axis using the second actuator includes driving the second stage arrangement such that the first stage is supported;
driving the first stage using a third actuator arrangement, the third actuator arrangement being carried on the second stage arrangement, wherein driving the first stage using the third actuator arrangement includes directly driving the first stage along a third axis.

21. The method of claim 20 wherein driving the first stage using the third actuator arrangement further includes directly driving the first stage about the first axis.

22. The method of claim 21 wherein driving the first stage using the third actuator arrangement further includes directly driving the first stage about the second axis.

23. The method of claim 20 wherein the first stage is monolithic, and the third actuator arrangement includes an air bearing that interfaces with the first stage.

24. The method of claim 20 wherein the stage is arranged to support a plurality of reticles.

25. A method of performing photolithography comprising the method of claim 20.

26. An apparatus, comprising:
a fine stage controllable in six degrees of freedom (6DOF) and configured to support an object to be patterned while moving in a scanning direction;
one or more coarse stages, each having first actuators that apply a vertical force to support and position the fine stage; and
a countermass assembly having second actuators that accelerate the coarse stage and the fine stage in the scanning direction.

27. The apparatus of claim 26, wherein the countermass assembly includes a first subset of the second actuators to accelerate the fine stage in the scanning direction.

28. The apparatus of claim 27, wherein the first subset of actuators also accelerates the coarse stage.

29. The apparatus of claim 27, wherein the countermass assembly further comprises a second subset of the second actuators that accelerates the coarse stage.

30. The apparatus of claim 27, wherein the first subset of the second actuators also moves the fine stage in a direction perpendicular to the scanning direction.

31. The apparatus of claim 26, wherein the countermass assembly comprises a rigid rectangular shaped frame.

32. The apparatus of claim 26, wherein the countermass assembly includes two masses having a length that is substantially the same as the scanning direction.

33. The apparatus of claim 32, wherein the two masses are interconnected by one or more cross-members.

34. The apparatus of claim 26, wherein the countermass assembly is attached to a base.

35. The apparatus of claim 26, wherein the countermass assembly is capable of moving the coarse stage and the fine stage in one of the following:
one degree of freedom;
two degrees of freedom;
three degrees of freedom;
four degrees of freedom;
five degrees of freedom; or
six degrees of freedom.

36. The apparatus of claim 26, wherein the first actuators on the one or more coarse stages are electro-magnets.

37. The apparatus of claim 26, wherein the first actuators on the one or more coarse stages further include antigravity devices.

38. The apparatus of claim 37, wherein the antigravity devices comprise: air pistons, bellows or permanent magnets.

39. The apparatus of claim 1, wherein the one or more coarse stages move in one of the following:
one degree of freedom;
two degrees of freedom;
three degrees of freedom;
four degrees of freedom;
five degrees of freedom; or
six degrees of freedom.

40. The apparatus of claim 26, wherein the fine stage does not include any hoses or cables connected to the fine stage.

41. The apparatus of claim 26, wherein the fine stage further comprises one of the following:
a reticle stage in a lithography tool for supporting a reticle; or
a wafer stage in a lithography tool for supporting a wafer.

42. The apparatus of claim 26, wherein the fine stage is configured to support a second object.

43. The apparatus of claim 26 further comprising a second fine stage configured to support a second object, the second fine stage being supported and positioned by the one or more coarse stages.

44. The apparatus of claim 26, wherein the object is one of the following:
a reticle; or
a semiconductor wafer.

45. The apparatus of claim 26, wherein the second actuators generate a net force directed through the center of gravity of the fine stage.
